(19) United States
(12) Patent Application Publication
(10) Pub. No.: US 2017/0201631 A1
(43) Pub. Date: Jul. 13, 2017

(54) Method and Apparatus for Charging a User Device

(71) Applicant: Charge-Up LLC, Boston, MA (US)

(72) Inventor: Tameem Hourani, Boston, MA (US)

(21) Appl. No.: 15/400,062

(22) Filed: Jan. 6, 2017

Related U.S. Application Data
(60) Provisional application No. 62/275,920, filed on Jan. 7, 2016.

(51) Int. Cl. H04M 19/00; H02J 7/00; H04M 1/725

(52) U.S. Cl. CPC H04M 19/00; H04M 1/72519; H02J 7/0047; H02J 2007/0001; H02J 2007/005; H02J 2007/0096

(57) ABSTRACT

The wireless charging unit is a utility device that can be used to charge a user device with power, and may be controlled by an online server that can approve or deny the request to begin charging. The online server may also have a capability to send video and image advertisements, surveys, inventory listings, data collection, SMS alerting, or other messages to the charging unit over the Internet or other wide area network, using Wi-Fi or cellular communication protocols to send signals and data to the charging unit. The online server may be used to log information from the charging units, as well as to control a charge-activation circuit to enable or disable the charging unit to charge the user device.

### RELATED APPLICATION

This application claims the benefit of U.S. Provisional Application No. 62/275,920, filed on Jan. 7, 2016. The entire teachings of the above application are incorporated herein by reference.

### BACKGROUND

Today's wireless devices need periodic charging. A mobile phone, for example, tends to be charged by its user when at a location for several hours, such as at home or in the office. When engaged in social activities, such as dining, charging a wireless device is not often possible.

### SUMMARY OF THE INVENTION

An embodiment of the present invention is a wireless charging unit, also referred to herein as a “wireless charger,” that can provide charging power from an internal power source to a wireless device. The embodiment can be provided to patrons of business establishments, for example, such as to customers dining at a restaurant. The embodiment may be a wireless charger that provides a user display that can display messages, such as advertisements, surveys, inventory listings, data collection, alerting including short message service (SMS) alerting or any other message-based alerting, and other such message content to the user of the wireless charger. The wireless charger may be configured to capture data regarding charging activities, such as length of chargings or amount of power delivered to a wireless device.

An embodiment of the present invention includes a method, and corresponding apparatus, of charging a user device. The method comprises approving, via a communications network, activation of a charging unit to deliver charging power to a user device responsive to a request, via the communications network, initiated by the charging unit.

The method may further comprise delivering content to the charging unit prior to or during delivery of the charging power, the content being formatted in a manner enabling the charging unit to provide the content to the user of the user device, the content being visual or audible content. The method may still further comprise enabling a manager to control the content to be delivered to the charging unit. The method may yet further comprise enabling the manager to control the content that is to be displayed by the charging unit during times when the charging unit is not delivering power.

The method may further comprise enabling a manager to configure the charging unit via the communications network.

The method may also further comprise collecting analytics based on information related to the delivery of charging power; or collecting data and generating the analytics based on the information related to the delivery of the charging power.

The method may include, for the approving of the activation, transmitting a charging activation approval indicator capable of being transmitted via a wireless link to the charging unit.

Another embodiment of the present invention may include a method, and corresponding apparatus, of charging a user device. The method may comprise, by a charging unit, requesting approval from a server, via a communications network, to activate charging of a user device; and activating delivery of charging power from the charging unit to the user device following receipt of a charging activation approval indicator from the server via the communications network.

The method may further comprise displaying content, received via the communications network, to a user of the user device via a graphical user interface of the charging unit. The method may still further comprise displaying the content, via the graphical user interface, to the user during the delivery of power to the user device. The method may yet still further comprise displaying the content or other content to the user via the graphical user interface during times when the charging unit is not delivering the power.

The method may further comprise applying a configuration at the charging unit in accordance with configuration settings controllable by a manager via the communications network.

The method may further comprise transmitting analytics, or data used in determining the analytics, from the charging unit to the server via the communications network, the analytics being based on the delivery of charging power.

The method may further comprise, by the charging unit, requesting the approval and receiving the charging activation approval indicator via a wireless link.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a diagram of a scene in which an embodiment of the present invention may be employed.

FIG. 1B is a top view diagram of an external view of a wireless mobile phone charger (“wireless charger”) in accordance with an embodiment of the present invention.

FIG. 2A is a network diagram that illustrates the wireless charger in communication with a network server via a wide area network.

FIG. 2B is a detailed flow diagram of an example operational flow of the wireless charger within a wide area network.

FIG. 3 is a block diagram of functional elements of the wireless charger.

FIG. 4 is a flow diagram of the operations of the network server and the wireless charger that illustrates their interoperation.

FIGS. 5A and 5B are detailed flow diagrams of the operations of the wireless charger that illustrates charging functions and display functions during charging and non-charging states.

FIG. 6 is a diagram of a database that is used to support media services for the wireless network device.

FIG. 7 is a flow diagram of operations of media delivery services available through the wireless charger.

FIG. 8 is a flow diagram of operations of the wireless charger in connection with a user device.

### DETAILED DESCRIPTION OF THE INVENTION

A description of example embodiments of the invention follows.

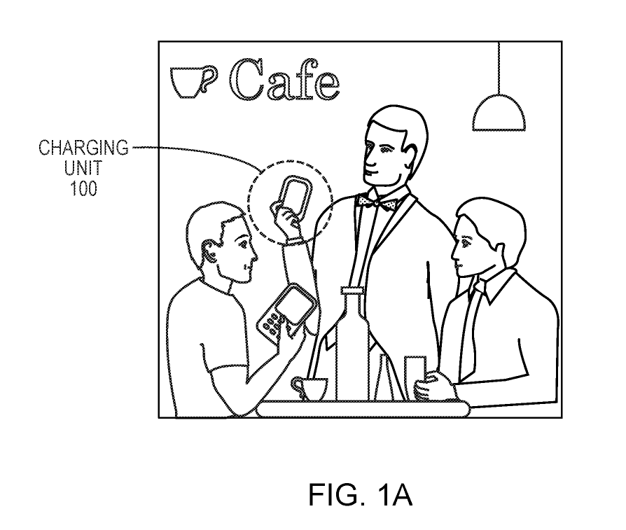

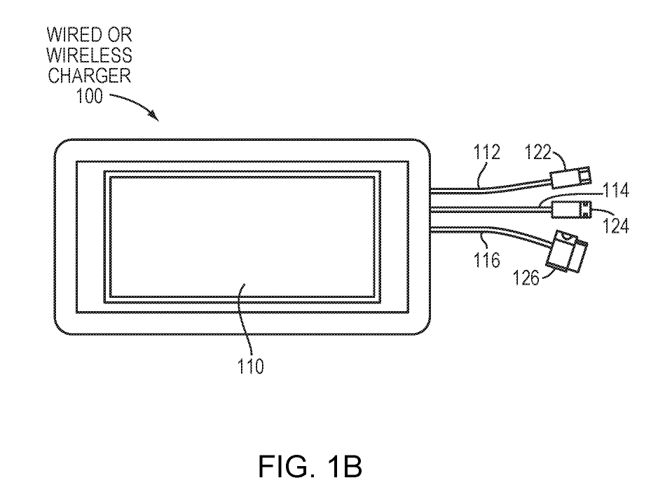

FIG. 1A is a scene in a restaurant in which a waiter asks patrons if the patrons would like to use a wireless charging device 100, also referred to herein as a wireless charging unit or wireless charger.

FIG. 1B is a three-dimensional diagram of an external view of the wireless charger 100 in accordance with an embodiment of the present invention. The wireless charger 100 may be used to charge a mobile phone or other device that employs a rechargeable power source.

The wireless charger 100 contains a Liquid Crystal Display (LCD) 110 or other screen that is used to interact with the user. The LCD 110 may be a touch screen that shows text and may include a graphical button (not shown) during an operational state allowing the user to start a phone charging process. The device may have a proprietary or standard magnetic power connecter or other power connector on one end that allows it to be charged by a provided power cable (not shown). The magnetic power connector may be round and contains a positive and negative lead to accept power via corresponding positive and negative leads of an interface end of the power cable. Once the interface end of the power cable is within a given distance, such as 10 MM, of the power connector on the wireless charger 100, the interface end magnetically snaps into place.

The other side of the wireless charger 100 is an outlet with three wires 112, 114, 116. The wires 112, 114, 116 terminate to three different tips 122, 124, 126 for an ability to charge devices with different input ports. The wires may vary between 15 cm and 30 cm in length depending on the model, and may be coated with industrial rubber.

The wireless charger 100 may have a logo on the bottom half of the top of its case.

The LCD screen 110 enables the user to start the charging process. Once the charging is enabled, the screen 110 may be used to display advertisements, surveys, inventory listings, data collection, alerting (such as SMS alerting), or other messages that are synced from online servers (not shown) via computer network, such as the Internet (not shown). The advertisements, surveys, inventory listings, data collection, alerting, or other message content may be loaded at the beginning of each use of the wireless charger 100 and may be on a schedule set by the server or other network device or by the wireless charger 100 itself.

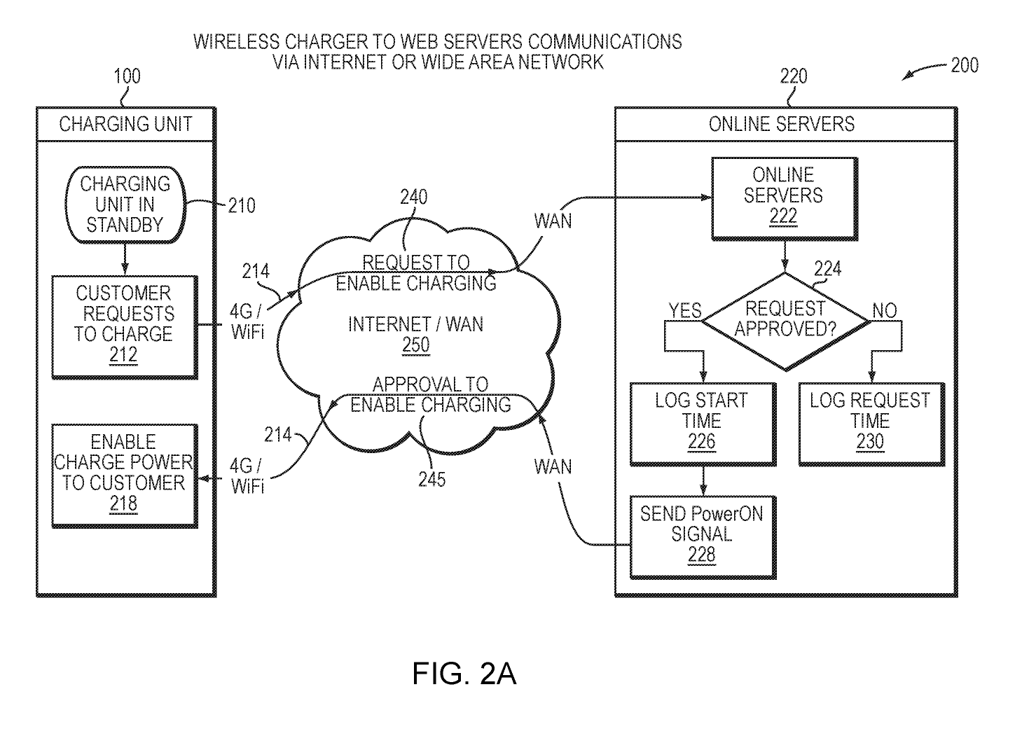

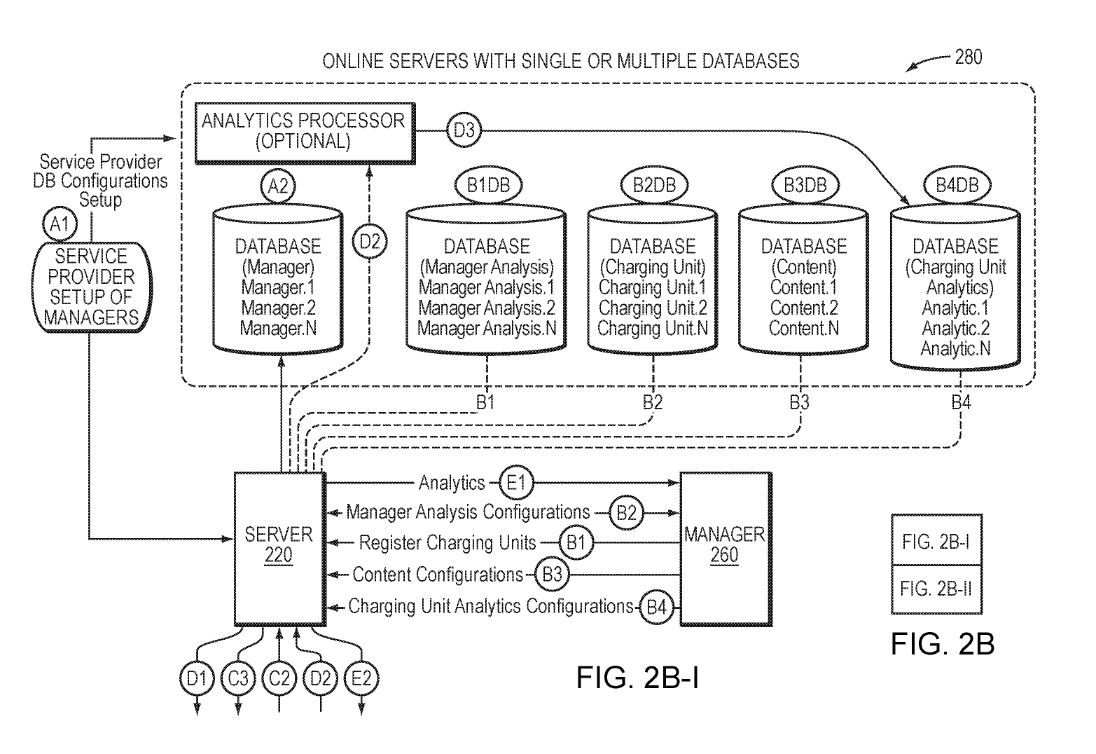

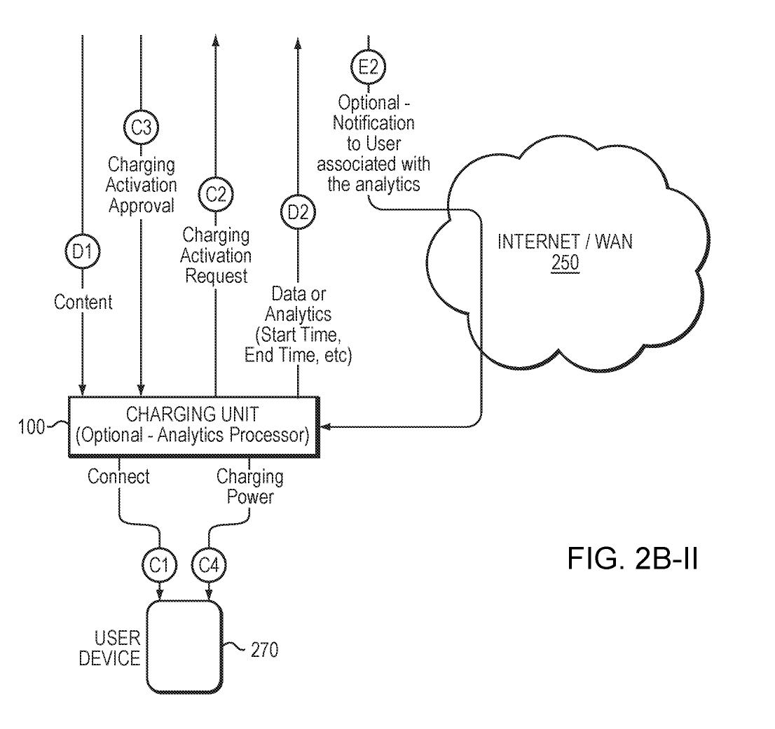

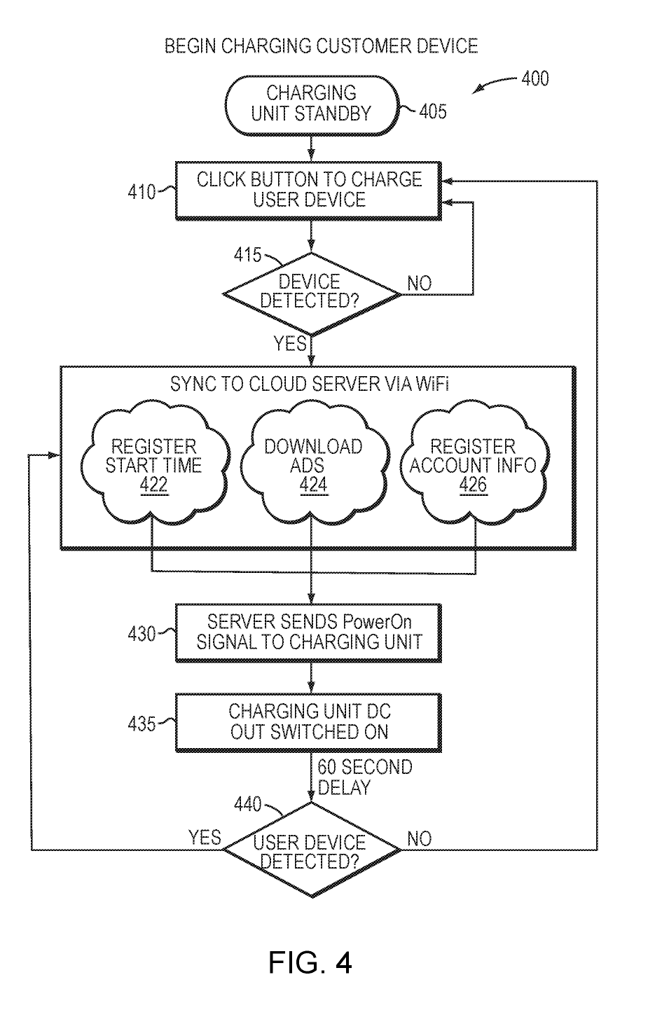

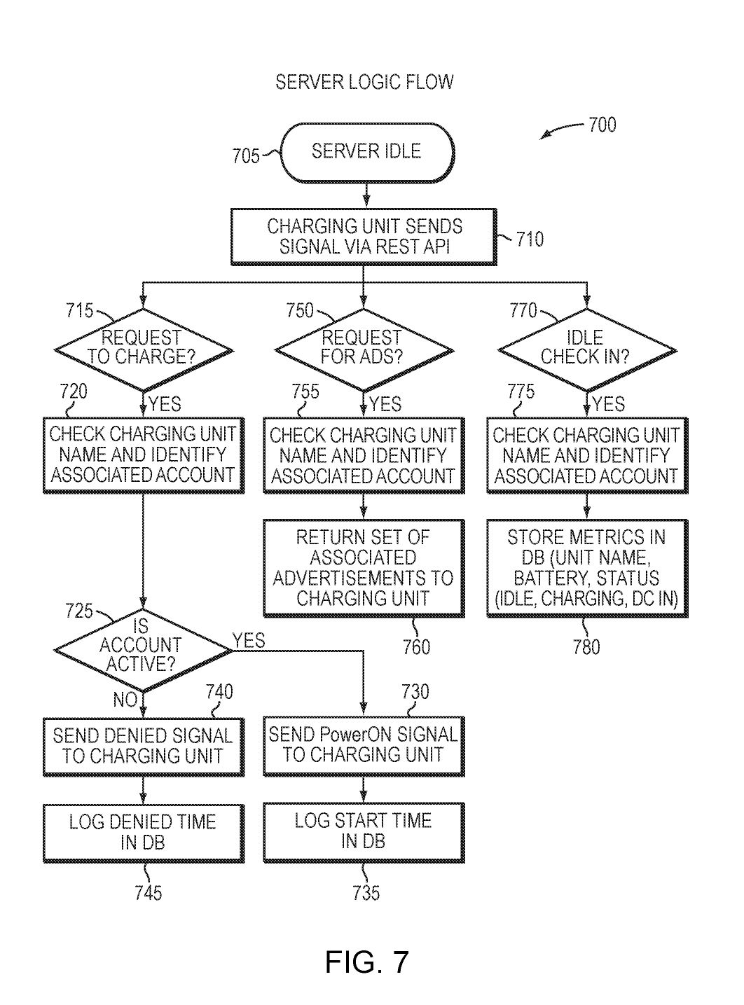

FIG. 2A is a network diagram 200 that illustrates a wireless charger 100 in communication with a network server 220 via a wide area network 250. The left side of the figure shows the logical flow of engaging in standby 210 the wireless charger 100, interchangeably referred to herein as a charging unit. Once the unit 100 is engaged in standby 210 and the user (customer) requests 212 to begin the charging process, a request to enable charging 240 is sent out over the unit's Wi-Fi or Cellular connection 214. The request travels across the Internet or a private wide area network 250 that reaches the one or more online servers 220. After the request arrives at the one or more online servers 220, the online servers 220 analyze 222 the request based on multiple factors explained in reference to FIG. 4 and FIG. 7.

FIG. 2B is an overall flow diagram 280 showing the data flow of the entire system. The flow diagram is defined as five subflows: A1 and A2; B1-B4; C1-C4; D1-D3; and E1 and E2.

At A1, the service provider sets up one or more managers on the platform. This data flows to the server 220, as well as the database (DB) labelled as A2 to setup the database configurations. The second phase of the process is for the manager 260 to register the units 100 as seen at B1. This data is then stored in the DB labelled as B1DB. Once the units 100 are registered, the manager 260 can send and receive information (analysis configurations) to and from the server 220 regarding the units 100, as shown at B2. This data is then stored in the DB labelled as B2DB. At B3, the manager 260 configures the content that will be displayed on the units 100, by sending the data to the servers 220 and configuring them. The content may include, without limitation, advertisements, surveys, inventory listings, data collection, message alerting (e.g., SMS alerting) and such. This data is then stored in the DB labelled as B3DB. At B4, the data flow from the manager 260 to the servers 220, in order to set the analytics information (configurations) on the charging units 100 that is set on the server 220. This data is then stored in the DB labelled as B4DB.

At C1 in FIG. 2B, the charging process for the user device 270 begins. Once the device 270 is connected to the charging unit 100 at C1, a Charging Activation Request is sent to the server 220 as shown in C2. The server 220 then analyzes the request and sends back a response based on some analytics that take place on the server 220 depending on multiple factors. The decision is then sent back to the charging unit 100, as indicated by at C3, which then turns on the power to the user device 270, as indicated at C4. After C4 is complete, the servers 220 then begin the flow of the analytics data to and from the charging unit 100. D1 shows that the initial information sent to the unit 100 is the content from the server 220 to the charging unit 100 retrieved from one of the databases in part B of the flow. The information sent at D1 from the server 220 to the charging unit 100 may be in the form of message alerting via a standard messaging communication protocols, such as short message service (SMS). The message alerting (SMS alerting) is further populated to the user device 270 for notification to the end user. As soon as this is complete, the charging unit 100 sends back some data or analytics information (e.g., start time, end time, etc.) to the servers 220 via D2 on the diagram 280.

Continuing to refer to FIG. 2B, at E1, the availability for the manager 260 and server 220 to exchange analytical information through the platform is indicated. The information is stored on the servers 220 from multiple sources, and the managers 260 can connect to the server 220 to either add or read some analytics information. At E2, an optional notification associated with the analytics flows to the end user through the manager's configuration down to the charging units 100.

As shown in FIG. 2A, after a decision is made on approving the request 224 on the servers 220, a timestamp is recorded of the request. If the decision is to deny the charging from starting, the request time is logged 230 and the request is stopped. If the decision is to allow the charging to start, the start time is logged 226, and then a PowerON signal is initiated (sent) 228 from the servers 220. The servers 220 then respond to the initial request 240 by sending out a call or other signal of approval to enable charging 245 to the requesting charging unit 100.

The call travels through the Internet or a wide area network 250 back to the requesting charging unit 100, thereby enabling 218 the charge power to the user (customer) to begin the charging of the user's device. Once the approval signal is received by the charging unit 100, the charging process is started.

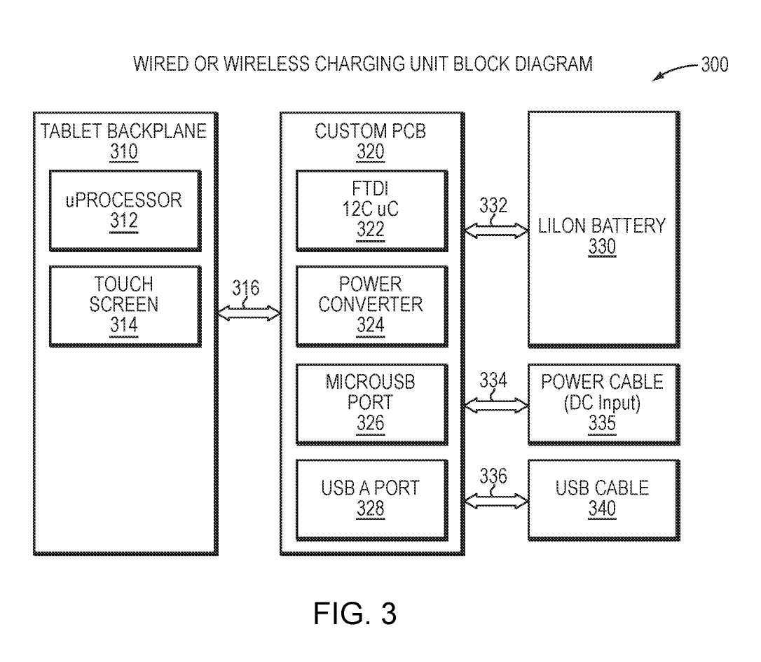

FIG. 3 is a block diagram 300 of example charging elements inside of an embodiment of the charging unit 100. The block diagram 300 shows the main components used to build and operate the unit 100. The left block on the diagram shows the charging unit tablet backplane 310 with associated user interface screen 314. This is the main component that is displaying the images to the user, and collecting the user's interactions through the screen 314, which may be a touch screen. This component has a built-in microprocessor 312, as well as a touch screen IPS LCD 314. This unit 100 also had a micro USB (not shown) that is used to communicate with the custom build PCB 320 shown in the block diagram 300. The custom PCB 320 may have a FTDI microprocessor 322 on it that is used to communicate back and forth with the backplane 310. This communication travels using the PCB's MicroUSB port 326, as well as the unit's MicroUSB port (not shown) via MicroUSB connection 316. This port 326 is used to send data from the PCB 320 to the backplane 310, as well as provide power to the backplane 310. The PCB 320 may have a USB A port 328 on it, which is the port used to charge the user's devices 270. This port 320 may have a USB or other cable 340 connected to it that extrudes the case with three exposed cables 336. The PCB 320 may also have two contacts for allowing power to flow in and out of the PCB 320. One set of leads 332 connects to a power storage or generation source 330, such as a Lithium Ion battery, which is housed inside the case. The second set of leads 334 on the PCB 320 is used to connect the PCB 320 to a Power Cable (DC input) 335 from an external power source.

The PCB 320 may employ multiple circuits that serve different purposes. One circuit is used to charge the battery 330 connected to the PCB 320. This circuit accepts a 5V 2A power source, and then converts the power source to charge the internal Lithium Ion battery 330 as well as the tablet 310 connected to the PCB 320. Another circuit is used to disable power to the backplane 310 if the battery voltage drops below a safe level. This is the internal protection circuit. Yet another circuit is used to enable and disable the power output to the USB A port 328. This circuit is controlled by the FTDI I2C microprocessor 322, which is controlled by the backplane 310 through the MicroUSB connection 316.

FIG. 4 is a flow chart 400 that describes the process of starting a charge using the wireless charging unit 100. Before starting the charging process, the charging unit 100 is in standby 405. The user will begin the charging process by pressing 410 the button on the device's LCD screen. After the button is pressed, the charging unit 100 tries to detect 415 the user's device 270. If the device 270 is not detected, the unit 100 goes back to displaying the main screen with the button on it. If the user's device is detected, the charging unit sends a request to the webservers 220 to begin the charging process.

After the request reached the servers 220, the servers 220 collect information from the charging unit 100. If the charging unit 100 is approved to start charging, the servers register 422 the start time of the request, and provide 424 the correct advertisements, surveys, inventory listings, data collection, alerting, or other message(s)/content to be displayed on the charging unit 100. The servers 220 also register 426 account information and authenticate the charging unit 100 against the servers 220 to make sure it is correctly registered to the server 220.

If the unit 100 is approved to begin charging, the server 220 sends 430 a PowerON signal back to the charging unit 100. Once the signal arrives back to the charging unit 100, the unit sends 435 a signal to the PCB 320 to turn the power (DC out) on USB A port 328. After the power is turned on, the device waits 60 seconds and attempts to detect 440 the user's device 270 again.

If the device 270 is detected, the charging unit 100 continues to leave the power on, and check in with the server 220 to update 422 the time stamp and harvest 424 any new advertisements, surveys, inventory listings, data collection, alerting, messages, or other content that are to be displayed. This 60 second loop continues to run until the user's device 270 is no longer detected by the charging unit 100. Once this happens, the unit returns to its main screen, and display the button that begins the charging request again for a new user.

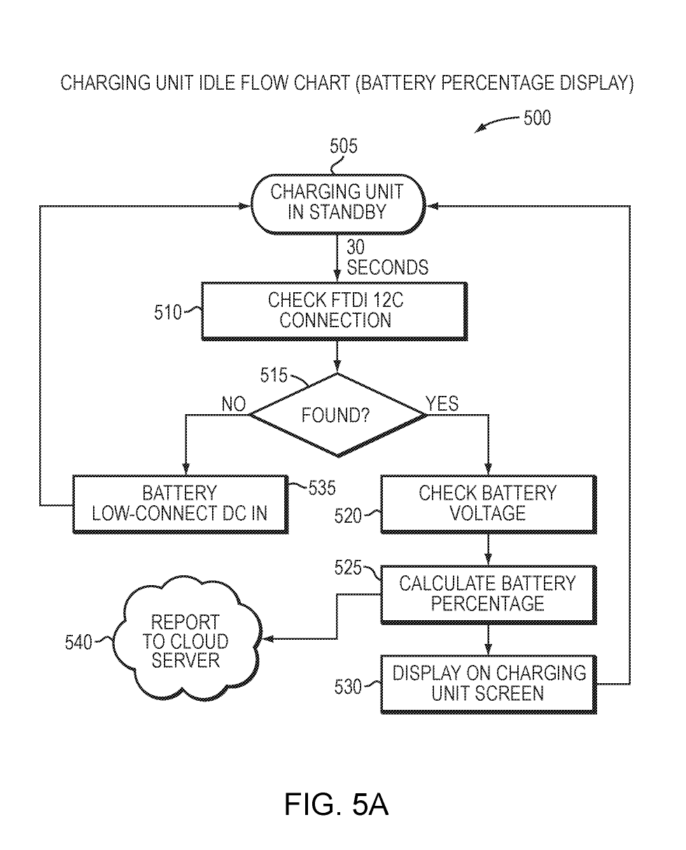

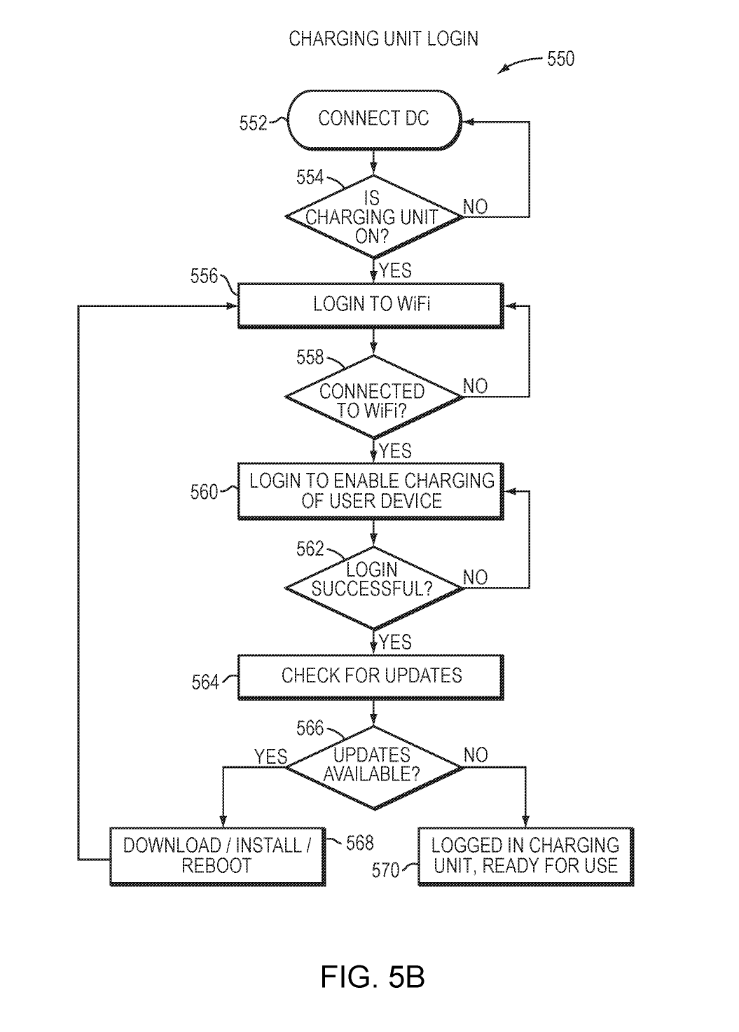

FIG. 5A is a flow chart 500 of the process of components interaction with each other and with the servers 220 while the unit 100 is idle (i.e., standby). While the unit 100 is in standby 505, it runs through a 30 second or other duration look that starts off by attempting to detect the PCB 320 during a check FTDI 12C connection operation 510. If the PCB 320 is not detected/found 515, a screen is displayed indicating 535 that the battery is low, and request to be connected to a DC power input. If the PCB 320 is detected, the backplane 310 requests to check 520 the battery voltage reading from the FTDI I2C processor 322 on the PCB 320. Once that voltage value is returned, it converts/calculates 525 the voltage reading to a battery percentage to be displayed 530 on the unit 100. Once that conversion is completed, the battery percentage is reported/sent 540 to the server 220 through an API call, and the battery percentage is displayed 530 on the main screen of the unit 100. After 30 seconds, the same process is initiated to update the screen with the available battery percentage while the unit 100 is idle.

FIG. 5B is a flow chart 550 that shows the initial login process for the charging unit 100 to connect it to the web servers 220. If the unit is turned off, then it must be connected 552 to its DC power input until it powers back on. Once the unit is powered on 554, the unit displays a screen prompting to be connected 556 to Wi-Fi or other wired or wireless interface. The screen displays a list of all available Wi-Fi networks in the area, and does not move past this screen until a Wi-Fi network is selected and successfully connected by entering the correct password.

The unit may be connected through any form of authentication and encryption, including pre-shared keys and certificate based authentication. After the device is successfully connected 558 to a Wi-Fi network, it moves to a login screen 560 to enable charging of the user device 270. The login screen prompts the user to enter a username and a password that are provided by the platform prior to giving the charger unit 100 to the user. This login prompt only appears upon the initial booting of the device 270. Once the device 270 is logged in, there is not a requirement to login after every use.

After the login credentials have been entered, they will be sent to the web servers 220 for authentication 562. If the authentication fails, the user is asked to login again. If the authentication passes, the unit is checked 564 for its software version and updates. If there is an update available 566 on the server for that unit, the user is prompted to update (download/install) 568 the charging unit. Once the update is completed, the unit 100 automatically reboots 568 and goes through the Wi-Fi and Login process again. Once the login is complete and there are no pending updates, the charging unit 100 is ready for use 570 and displays its idle screen, with the available battery percentage and the button to begin charging a user's device.

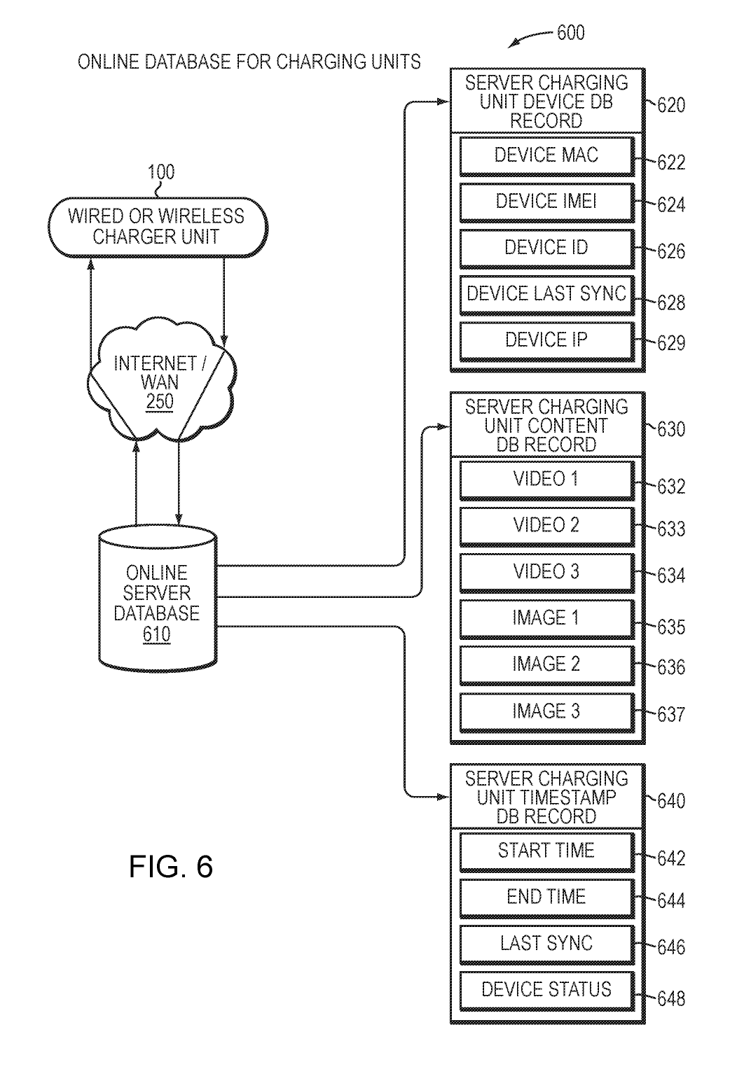

FIG. 6 is a flow chart 600 displaying the communications between the charging units 100 and the web servers 220, showing what information is stored on the web servers 220 and how the information is sent back to the charging units 100. They also show how the unit 100 is sending its own information to the web servers 220. The charging unit 100 initiates the communication to the web server 220 over the Internet 250 using a Wi-Fi or cellular connection 214, reaching the web servers databases 610. The web servers 220 have multiple databases used for different purposes of managing the charging units 100. The first database 620 is used to manage all the device information. Each device has its own record that contains information to help identify the health of the unit, as well as its location and its use. This information contains its MAC address 622, IMEI address 624, Device ID 626, its Last Sync date and time 628, and the devices IP address 629. All this information is updated every 60 seconds or other timing to make sure that it's up-to-date on the servers' databases 610. The information is updated by Wi-Fi or cellular data from the charging unit 100 to the web servers 220. The second database 630 is used to house all of the advertising content for each charging unit 100. The charging units 100 have advertisements that are managed through the web GUI, and each unit has a list of video and image advertisements 632-637 that are uploaded prior to starting each charging cycle. This database tied the Device ID to the list of advertisements that must be uploaded to the charging unit after the request to start charging is approved. Note, in some embodiments surveys, inventory listings, data collections, message alerting (SMS alerting), and such are managed in place of or in addition to the advertising content (advertisements). The third database 640 is the charging records database, and is used to track a time based analysis of all events occurring on the charging unit 100. The events include a start time 642 for every time the charging unit 100 is used, and end time 644 for every time a device is no longer detected. It also tracks the device status 648 of the charging unit every 60 seconds, and the time stamp 646 for the last time the unit was synced to the online servers 220.

FIG. 7 is a flow chart 700 showing the logic process on the online servers 220 when they receive a request from the charging units 100. The charging unit 100 sends signals to the web servers 220 every 60 seconds. The signals are transferred over Wi-Fi or cellular networks 214, and arrive to the servers 220 through a wide area network 250. The devices 100 are communicating over a custom build REST API that is used for multiple communications back and forth between the units 100 and the servers 220. FIG. 7 begins with the server 220 idle 705. The first form of communication to the servers 220 is the charging unit sending 710 an idle signal to the servers 220 via the REST API. This signal is used when the charging unit 100 is idle and is checking in 770 to the server 220 to update its status. During this communication, the charging unit 100 will first request an authentication approval from the server 220. To authenticate the charging unit 100, the server 220 checks 775 the charging unit name and identifies the associated account. This is done using the authentication token that was received during the login process. Once the unit 100 is authenticated with the server 220, it sends its signal information to the server 220 containing information about its status. The information that is sent includes the units name, its ID, its battery percentage, and its status 720. The status of the device can be idle, connected to DC, or charging a user's device. This metrics information is stored 780 with a time stamp in the database on the online servers 220.

The second form of communication to the servers 220 is to request 750 advertisements from the servers 220. In other embodiments, other content may be requested from the servers 220 including advertisements, surveys, inventory listings, data collection, message alerting (e.g., SMS alerting), and such. After the charging unit 100 sends 710 a signal request using the REST API, the charging unit 100 must authenticate with the servers 220 using the token stored from login. To authenticate the charging unit 100, the servers 220 check 755 the charging unit name and identify the associated account. Once the authentication is approved, the servers 220 will return 760 the set of related advertisements (or other content including surveys, inventory listings, data collection, SMS alerting, other such messages, and the like) to the charging unit 100 so they can be stored and cached on the unit for the next charging cycle to start.

The third signal request sent 710 from the charging unit 100 is to start a charging request 715, and is used to approve or reject the charging request. After receiving the request, the servers 220 authenticate the charging unit 100 using the token obtained during login. To authenticate the charging unit 100, the servers 220 check 720 the charging unit name and identify the associated account. After authentication is approved, the servers 220 will make a decision to approve or deny the charge request. The servers 220 will check 725 if this account is active or not. If the account is active, then the servers 220 will send 730 the PowerON signal back to the charging unit 100. Once the signal is sent, the servers 220 will log 735 a start time to the databases. If the account is inactive or disabled, the servers 220 will send 740 a denied signal back to the charging unit. Once the signal is sent, the servers 220 will log 745 a timestamp to record when the request was denied to the databases.

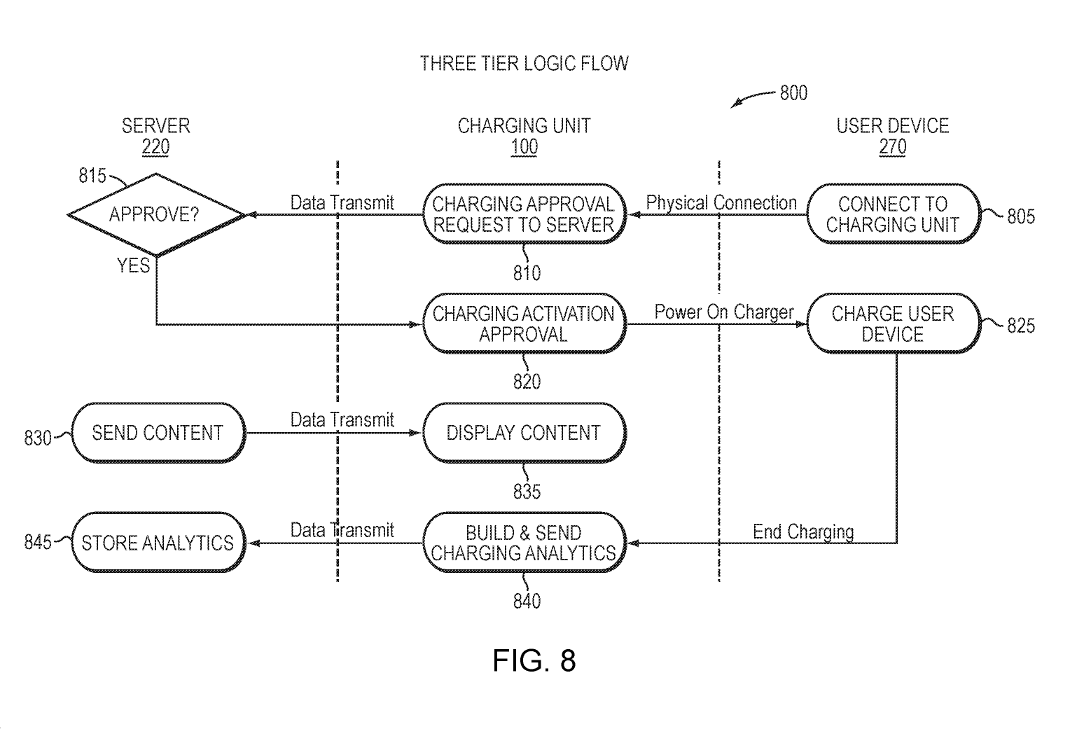

FIG. 8 is a flow diagram 800 that illustrates the three tier logic flow of data among a server 220, charging unit 100, and user device 270. FIG. 8 also illustrates charging activation of and power delivery by the charging unit 100 for power delivery to the user device 270. The data flow begins by a user device 270 connecting 805 to a charging unit 100 via a physical connection. In response, the charging unit 100 transmits 810 data containing a charging approval request to the server 220. The server 220 determines whether to approve 815 the request. If the server 220 grants 820 charge activation approval, the power on the charging unit 100 is activated to charge 825 the user device 270. Once the charging ends, the charging unit 100 builds and sends 840 charging analytics to the server 220, which stores 845 the analytics. The server 220 may also send 830 content via a data transmission to the charging unit 100. The content may include, without limitation, advertisements, surveys, inventory listings, data collection, and alerting (e.g., SMS alerting or other message-based alerting communications protocol), and other messages. The charging unit 100 may display 835 the received content on a screen of the user device 270 to a user.

It should be understood that various aspects of the embodiments disclosed herein may be implemented in the form of hardware, firmware, or software. If implemented in software, the software may be any computer software language that can be loaded and executed by a processor to cause a processor to perform operations consistent with the operations disclosed herein. The software may be stored in the form of instructions on any non-transitory computer-readable medium in operational communication with the processor. In the case of the wireless charging unit, the instructions may be stored on a non-transitory computer-readable medium local to or remote from the wireless charging unit. Instructions may be sent to the wireless charging unit via a wired connection or wireless connection.

While this invention has been particularly shown and described with references to example embodiments thereof, it will be understood by those skilled in the art that various changes in form and details may be made therein without departing from the scope of the invention encompassed by the appended claims.

What is claimed is:

1. A method of charging a user device, the method comprising:
approving, via a communications network, activation of a charging unit to deliver charging power to a user device responsive to a request, via the communications network, initiated by the charging unit.

2. The method according to claim 1 further comprising delivering content to the charging unit prior to or during delivery of the charging power, the content being formatted in a manner enabling the charging unit to provide the content to the user of the user device, the content being visual or audible content, and wherein the content includes at least one of advertisements, surveys, inventory listings, data collection, and short message service (SMS) alerting.

3. The method according to claim 2 further comprising enabling a manager to control the content to be delivered to the charging unit.

4. The method according to claim 3 further comprising enabling the manager to control the content that is to be displayed by the charging unit during times when the charging unit is not delivering power.

5. The method according to claim 1 further comprising enabling a manager to configure the charging unit via the communications network.

6. The method according to claim 1 further comprising:
collecting analytics based on information related to the delivery of charging power; or collecting data and generating the analytics based on the information related to the delivery of the charging power.

7. The method according to claim 1 wherein approving the activation includes transmitting a charging activation approval indicator capable of being transmitted via a wireless link to the charging unit.

8. A method of charging a user device, the method comprising:
by a charging unit, requesting approval from a server, via a communications network, to activate charging of a user device; and
activating delivery of charging power from the charging unit to the user device following receipt of a charging activation approval indicator from the server via the communications network.

9. The method according to claim 8 further comprising displaying content, received via the communications network, to a user of the user device via a graphical user interface of the charging unit, and wherein the content includes at least one of advertisements, surveys, inventory listings, data collection, and short message service (SMS) alerting.

10. The method according to claim 9 further comprising displaying the content, via the graphical user interface, to the user during the delivery of power to the user device.

11. The method according to claim 10 further comprising displaying the content or other content to the user via the graphical user interface during times when the charging unit is not delivering the power.

12. The method according to claim 8 further comprising applying a configuration at the charging unit in accordance with configuration settings controllable by a manager via the communications network.

13. The method according to claim 8 further comprising transmitting analytics, or data used in determining the analytics, from the charging unit to the server via the communications network, the analytics being based on the delivery of charging power.

14. The method according to claim 8 further comprising, by the charging unit, requesting the approval and receiving the charging activation approval indicator via a wireless link.
